(19) United States
(12) Patent Application Publication
(10) Pub. No.: US 2002/0196646 A1
(43) Pub. Date: Dec. 26, 2002

(54) Method and arrangement for providing a heat sink to a DC to DC converter and beneficial utilization of heat energy rejected by a DC to DC converter

(76) Inventors: Derrick E. Cook, Saline, MI (US); Peter A. Hatch, Dearborn Heights, MI (US); Paul W. Keberly, Canton, MI (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/683,317

(22) Filed: Dec. 13, 2001

Related U.S. Application Data
(60) Provisional application No. 60/255,371, filed on Dec. 13, 2000.

(51) Int. Cl. H02M 1/00

(52) U.S. Cl. 363/141

(57) ABSTRACT

Method and apparatus for utilizing heat-energy produced as a by-product from a DC to DC converter for productive purposes. The method includes providing a DC to DC converter adapted to be installed into an incorporating arrangement, such as a transport vehicle. The DC to DC converter produces heat-energy as a by-product of operation. The DC to DC converter is arranged in thermal communication with a receiving arrangement, such as a windshield assembly, for transferring heat from the DC to DC converter to the receiving arrangement. The receiving arrangement is of a nature that is advantageously affected by heat transferred thereto from the DC to DC converter. The receiving arrangement is utilized as a heat sink for accepting heat-energy produced as a by-product from the DC to DC converter during operation and the heat sink advantageously cools the DC to DC converter during operation.

### CROSS REFERENCE TO RELATED APPLICATIONS

The present patent application claims the benefit of U.S. Provisional Application No. 60/255,371 filed Dec. 13, 2000.

### BACKGROUND OF INVENTION

1. Technical Field

The present invention relates generally to DC to DC electric power conversion, and more specifically, to providing a heat sink for a DC to DC converter in which the heat sink typically has another primary function and is beneficially affected by the heat transferred thereto from the converter.

2. Background Art

It is well known in the electronics industries and arts that there is often a requirement to provide cooling capacity to certain electronic components. During operation, these certain heat producing components can become overheated due to their own operation to an extent that they fail to function properly until the heat load within their structure is reduced. In extreme cases, the heat load can cause irreversible damage. Examples of such electronic components include transistors and inductors, each of which produce significant amounts of heat during their operation. As a solution, it is conventionally accepted to associate heat sink bodies with these heat producing components so that through thermal conductivity the produced heat is drawn away from these electronic components and into the absorbing heat sink bodies. In the most typical of examples of such heat sinks, metal plates are utilized that are placed, most advantageously, in surface-to-surface contact with the heat producing component(s). Via this physical contact, heat is conducted from the higher temperature operating electronic component(s) to the lower temperature heat sink. In conventional configurations, the heat produced by an electronic component has been considered to be a waste by-product to be discarded without further benefit derived therefrom.

In view of the above described deficiencies associated with the use of known designs for heat sink configurations for electronic components, the present invention has been developed to alleviate these drawbacks and provide further benefits to the user. These enhancements and benefits are described in greater detail hereinbelow with respect to several alternative embodiments of the present invention.

### SUMMARY OF INVENTION

The present invention in its several disclosed embodiments alleviates the drawbacks described above with respect to conventionally designed heat sink configurations for electronic components and incorporates substantial beneficial features.

According to the present invention, it has been appreciated that there are certain situations in which certain existing structures can be associated with the heat producing components so that additional parts are not required to provide such heat sinks, when the overall incorporating structure that incorporates the DC to DC converter is considered. Still further, if strategically selected, a heat receiving component can be chosen as the heat sink and which actually benefits from the heat transferred thereto. In this way, not only is the heat from the electronic component no longer a wasted by-product, but it also positively affects the associated and heated component that serves as the heat sink.

As an example, vehicles are being developed which have at least two different voltage requirements onboard. In order to accommodate the different voltage systems, DC to DC converter(s) are provided onboard the vehicle which typically include in their structures certain electronic components, such as transistors and inductors, that produce heat and which must be cooled to assure their proper operation. Heretofore, these heat producing electronic components would have been associated with a heat sink, usually in the form of a large mass metal body to which the heat would be conductively transferred. Ultimately, the heat energy would have been absorbed and dissipated from this heat sink mass as a waste by-product of operation.

The present invention contemplates selecting a heat sink mass that is an existing member of the overall system into which the heat producing electronic components are incorporated. In this way, no additional components are required to be added to the incorporating arrangement. This can be important, especially in transport vehicles where it is always a goal to minimize weight and conserve space.

This exploitation has been found particularly suitable in electric vehicles, hybrid electric vehicles, and other vehicles of more conventional design, but which have at least two different voltage systems operating on board. In these types of vehicles, a DC to DC converter is provided for converting high to low voltages and low to high voltages. These DC to DC converter(s) normally include at least heat producing transistor(s) and inductor(s), each of which must be cooled, typically using a heat sink receiver.

One particularly advantageous application of the present invention in a transport vehicle requires utilizing a DC to DC converter to boost a conventional 12 volt electric power supply to a 42 volt power supply for powering a heating system for a window screen of the vehicle. As in conventional configurations, electric power is often provided to heat a window glass of a vehicle utilizing resistive elements for de-icing and de-fogging purposes. At least one new technology for such window heating prefers/requires the 42 volts referenced above. As such, a DC to DC converter is provided at a location which can be advantageously arranged near the windscreen(s) to be heated.

Since the end use of the boosted electric power is to provide heat, it has also been advantageously recognized that the heat produced in the conversion process may be likewise advantageously supplied to the glass of the windscreen(s). In this manner, the mass of the windscreen is used as the required heat sink and no additional components need be added for that purpose. Still further, since heating is often a desired quality at the windscreen(s), it has been discovered that the DC to DC converter can be advantageously associated with the windscreen(s) to heat certain areas that make best use of the rejected heat from the converter.

A particularly advantageous configuration has been discovered in which heat generated by the converter is input at areas of the windscreen's body that can be most benefited by the heat. In the case of a front windscreen, and sometimes a back windscreen, wipers are provided at the exterior surface of the glass and normally at a low resting position. The performance of the wiper(s) can be compromised if ice forms thereabout in this resting position. Therefore, the present invention recognizes this to be a particularly advantageous location for transferring generated heat from the DC to DC converter to a windscreen assembly. In the case of a heated windscreen, by so doing, ice that forms around the wiper assembly will be melted as a result of not only the primary heating affect supplied by the boosted voltage, but also from the heat generated by the electronic components. This configuration conserves energy, weight and space.

A windscreen is a particularly advantageous arrangement in which to incorporate the present invention because a predominant portion of the main body of glass is exposed to the exterior of the vehicle. Therefore, the substantial mass of the windscreen will certainly be almost always sufficient to accept the amounts of heat rejected from the electronic components of a DC to DC converter. Still further, because there will typically be air passing over the glass as the vehicle travels, a windscreen, and particularly a front windscreen can be expected to provide an adequate temperature differential to the electronic components and therefore provide a suitable heat sink, even in warm weather. Moreover, the heat from the electronic components can only advantageously affect the windscreen because there will never be a temperature sufficiently high coming from the DC to DC converter to harm the windshield assembly or cause discomfort or other ill-effects to the passengers.

It should be understood that the windscreen embodiment is but one example of advantageous configurations, particularly in transporting vehicles, that can beneficially take advantage of the heat rejected from a DC to DC converter. Another example may be appreciated in which components of an air conditioning system are used as the receiving heat sink. In these cases, the waste heat from the DC to DC converter can be advantageously transferred to an exposed component of the air transmitting assembly so that heat is dispensed or dissipated into the conveyed air. In this case, an intermediate transfer member may be provided that is placed in contact with both the heat rejecting electronic components and the air passing through the air conditioning system. It is also contemplated that in order to enhance the transfer of heat to the conditioned air, fin members or structures may be included that project from a heat plate into the air flow stream. In this way, not only is adequate cooling effect provided because of the constant supply of air flowing across the fins and heat plate, but the heat previously rejected as waste is now a beneficial contributor to passenger comfort by way of assisting the heating of air prior to distribution to the passenger compartment.

In at least one embodiment, the present invention takes the form of a method for utilizing heat-energy produced as a by-product from a DC to DC converter for productive purposes. The method includes providing a DC to DC converter adapted to be installed into an incorporating arrangement, such as a transport vehicle. The DC to DC converter produces heat-energy as a by-product of operation. The DC to DC converter is arranged in thermal communication with a receiving arrangement, such as a windshield assembly, for transferring heat from the DC to DC converter to the receiving arrangement. The receiving arrangement is of a nature that is advantageously affected by heat transferred thereto from the DC to DC converter. The receiving arrangement is utilized as a heat sink for accepting heat-energy produced as a by-product from the DC to DC converter during operation and the heat sink advantageously cools the DC to DC converter during operation.

The beneficial effects described above apply generally to the exemplary devices and mechanisms disclosed herein for heat sink configurations for electronic components. The specific structures through which these benefits are delivered will be described in detail hereinbelow.

### BRIEF DESCRIPTION OF DRAWINGS

The invention will now be described in greater detail in the following by way of example only and with reference to the attached drawings, in which:

FIG. 1 is a front perspective view of a DC to DC converter, taken from a position above the converter, exemplarily constructed according to the present invention.

FIG. 2 is a front-side elevational view of the DC to DC converter of FIG. 1.

FIG. 3 is a top view of an alternative configuration of a DC to DC converter constructed according to the present invention.

FIG. 4 is a right-end view of the DC to DC converter of FIG. 3.

FIG. 5 is a perspective view of a covered DC to DC converter according to the configuration of FIG. 1.

FIG. 6 is a perspective view of a vehicle showing a windshield assembly of the vehicle as the receiving arrangement that is in thermal communication with the DC to DC converter according to an embodiment of the present invention.

FIG. 7 is a partial top plan view of a vehicle showing an air conducting plenum of the air conditioning system of the vehicle as the receiving arrangement that is in thermal communication with the DC to DC converter according to an alternate embodiment of the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

Referring to the Figures, an arrangement for utilizing heat-energy produced as a by-product from a DC to DC converter 15 for productive purposes is illustrated. The arrangement includes the DC to DC converter 15 adapted to be installed into the incorporating arrangement, such as a transport vehicle. The DC to DC converter 15 produces heat-energy as a by-product of the operation of several of its constituent components. Those heat producing components include transistors secured under a pressure plate 40 and an inductor 20. An inner ring-shaped core and surrounding cooper wire winding are included in the inductor 20. A circuit board 25 is provided and upon which the electrical connections are accomplished and various component parts 55 are mounted. Among those component parts are capacitors 30 and 35, resistors, diodes and other electrical components familiar those skilled in the electronic arts.

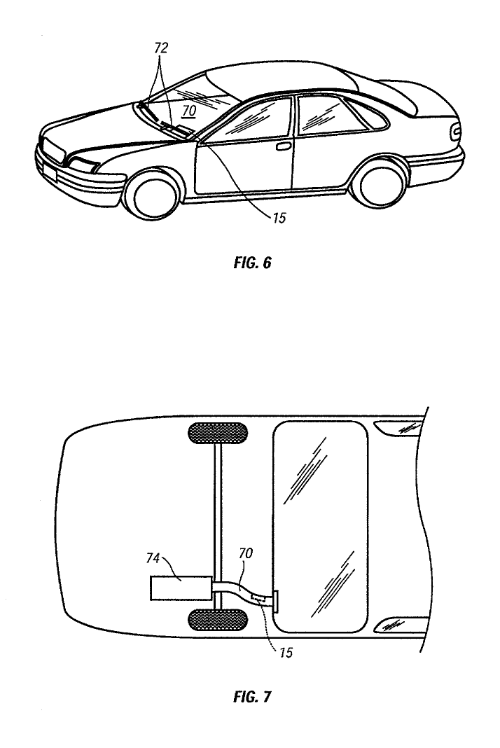

The DC to DC converter 15 is arranged in thermal communication with a receiving arrangement 70, such as a windshield assembly as shown in FIG. 6, for transferring heat from the DC to DC converter to the receiving arrangement 70. The receiving arrangement 70 is of a character that is advantageously affected by heat transferred thereto from the DC to DC converter 15. The receiving arrangement 70 is utilized as a heat sink for accepting heat-energy produced as a by-product from the DC to DC converter 15 during operation and the heat sink advantageously cools the DC to DC converter 15 during operation.

In operation, the DC to DC converter 15 adjusts a power supply voltage at the incorporating arrangement. The source voltage may be boosted to a greater voltage or may be bucked to a lower voltage.

In a preferred embodiment, a component member of the receiving arrangement 70 is utilized as the heat sink for the DC to DC converter 15. A heat transfer member 5 is associated with the DC to DC converter 15 and the receiving arrangement 70 for establishing thermal communication from the DC to DC converter 15 to the receiving arrangement 70. A portion of the heat transfer member 5 is arranged into surface-to-surface contact with a portion of the receiving arrangement 70, the surface-to-surface contact facilitating thermal communication from the DC to DC converter 15 to the receiving arrangement 70.

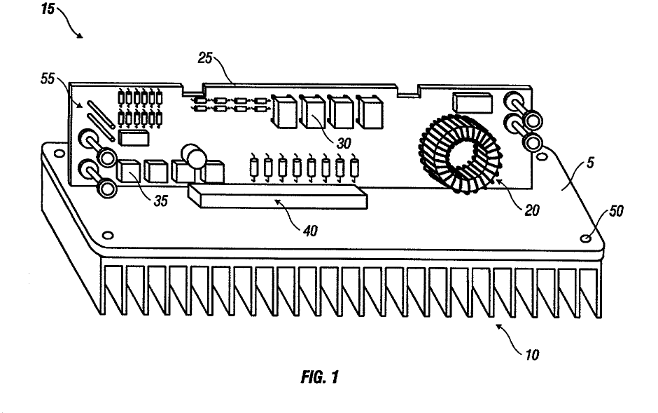

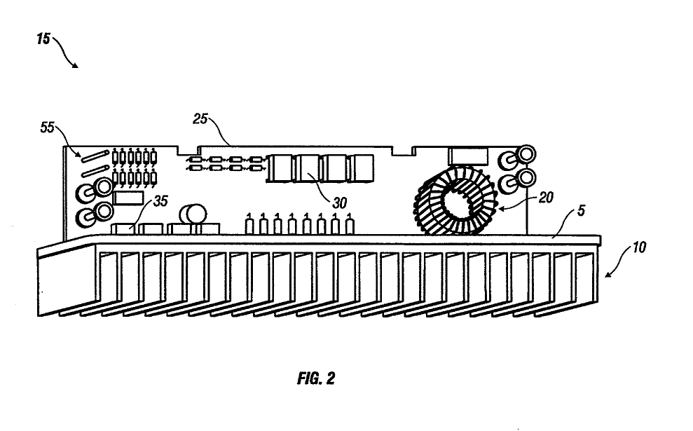

As may be appreciated in FIGS. 1, 2, 4 and 5, fins 10 are positioned on the heat transfer member 5 for dissipating heat out of the transfer member into the receiving arrangement 70, the dissipation of heat providing a benefit to the receiving arrangement 70. The fins 10 are provided to increase an exposed surface area of the heat transfer member 5 for better dissipating heat out of the transfer member 5 and into the receiving arrangement 70. The dispensation of heat potentiates beneficial effects of the receiving arrangement 70.

In a further embodiment of the invention, the DC to DC converter 15 is installed into an incorporating arrangement so that heat-energy produced by the DC to DC converter 15 is transferred therefrom to the receiving arrangement 70 for a benefit to the incorporating arrangement. The DC to DC converter 15 is configured with respect to the receiving arrangement 70 so that heat transferred from the DC to DC converter to the receiving arrangement 70 is applied to a benefited portion of the receiving arrangement that is, at least part time, advantageously affected by heat received from the DC to DC converter 15.

The benefited receiving arrangement 70 should be selected so that sufficient heat is always accepted from the DC to DC converter 15 thereby assuring that proper cooling will be provided to the DC to DC converter 15 and so that heat transferred from the DC to DC converter 15 to the benefited portion of the receiving arrangement 70 is never disadvantageously affected by the heat received from the DC to DC converter.

As indicated above, the receiving arrangement 70 may be a windscreen assembly as shown in FIG. 6, with the windscreen member actually serving as the heat sink. The heat from the DC to DC converter 15 is imposed on the windscreen member at a location adjacent to the resting position of the wipers 72. In the case of freezing conditions, this point of imposition is greatly benefited by the extra heat supplied from the DC to DC converter 15. This configuration can be appreciated by assuming that the windscreen takes the place of the heat transfer member 5 in the illustrative Figures. Also in this configuration, the fin members 10 would be deleted from the arrangement since the heat generated by the DC to DC converter is imposed directly to the windscreen member.

Regarding the embodiment that does incorporate the fin members 10, a preferred receiving arrangement 70 may be seen as an air conducting plenum of an air conditioning system 74 of a carrying vehicle as shown in FIG. 7. In this case, the arrangement shown in FIG. 1 would be configured so that the heat transfer member 5 establishes thermal communication from the DC to DC converter 15 to an interior passageway of the air conducting plenum. At least a portion of the heat transfer member 5 is exposed to an air flow conducted through the interior passageway of the air conducting plenum. In this configuration, the fins 10 are positioned for potentiating a dissipation of heat out of the transfer member 5 into the air conditioning plenum. This dissipation of heat provides a benefit, at least at certain times, by heating air flowing in the interior passageway of the air conducting plenum prior to the air's distribution to a passenger compartment of the carrying vehicle. In a preferred embodiment, the heat transfer member 5 and fin member(s) 10 are unitarily constructed to facilitate heat conduction thereacross.

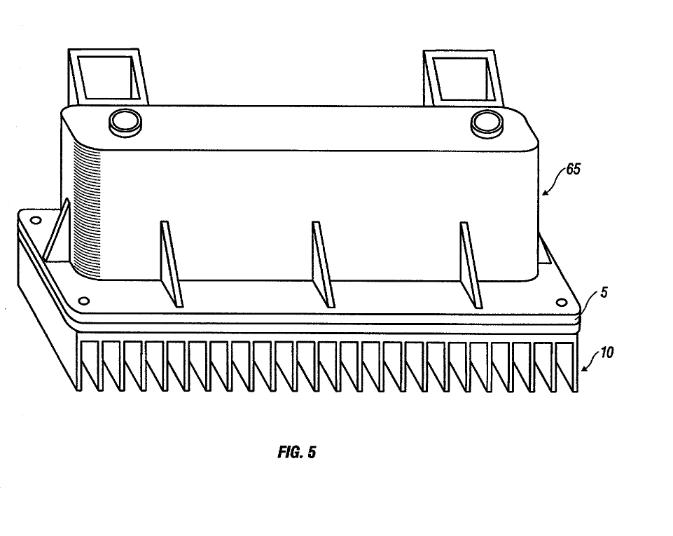

FIG. 5 illustrates a protective cover 65 provided to protect the more vulnerable components of the DC to DC converter 15. Securement receivers 50 are provided for securing the cover 65 to the heat plate 5.

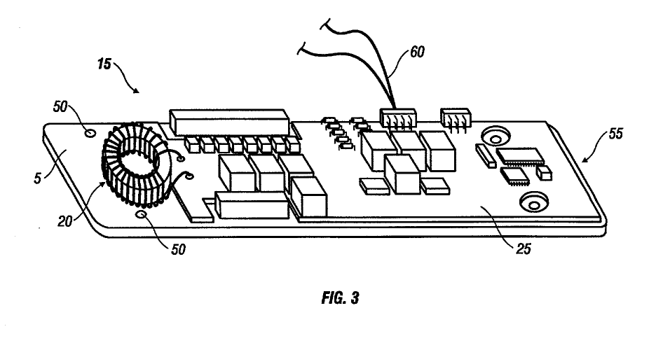

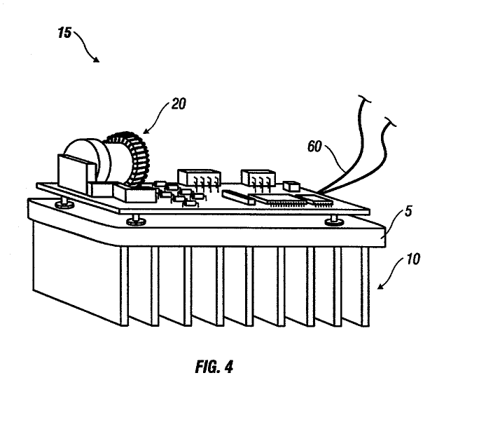

FIGS. 3 and 4 show connective wiring 60 that is used to control the operation of the DC to DC converter 15 and its several constituent components.

It is contemplated that the DC to DC converter assembly may be packaged on the heat transfer plate 5 or may be directly mounted to the heat sink member as may be the case when a windscreen is used as the heat sink member. In either case, heat transfer from the heat producing components, such as the inductor 20 and the transistors held under the pressure plate 40 is accomplished utilizing surface-to-surface contact. It is, however, contemplated that conductivity may be enhanced utilizing certain compounds that increase the conductive contact between the members. In the case of the inductor 20, portions of the included copper coil are placed in contact with the plate 5 or other receiving member such as a windscreen member. The transistors are secured into pressing engagement with the heat transfer member 5 utilizing the pressure plate 40. This contact may also be directly with the heat sink member.

When packaged on a flat heat transfer member 5 without the fin members 10, the flat surface of the transfer member 5 opposite the DC to DC converter components may be placed in direct surface-to-surface contact with the heat sink, such as the windscreen shown in FIG. 6. As indicated above, if heating of a particularly beneficial receiving area is desired, the transfer plate 5 can be positioned at or near that location; for instance, adjacent to the resting location of the windscreen wiper blade(s) 72.

In the instance of incorporation into an air distribution arrangement of a vehicle's air conditioning system 74 as shown in FIG. 7, the exemplary embodiment of FIG. 1 may be considered and in which the transfer plate 5 is arranged to form a portion of a wall of the plenum, with the DC to DC converter 15 outside the plenum and the fins projecting into the interior air passageway.

By way of the several examples disclosed herein, a DC to DC converter and advantageously associated heat sink components have been described. These and other variations which will be appreciated by those skilled in the art are within the intended scope of this invention as claimed below. As previously stated, detailed embodiments of the present invention are disclosed herein; however, it is to be understood that the disclosed embodiments are merely exemplary of the invention that may be embodied in various forms.

1. A method for utilizing heat-energy produced as a by-product from a DC to DC converter for productive purposes, said method comprising:
providing a DC to DC converter adapted to be installed into an incorporating arrangement, said DC to DC converter producing heat-energy as a by-product of operation;
arranging said DC to DC converter in thermal communication with a receiving arrangement for transferring heat from said DC to DC converter to said receiving arrangement, said receiving arrangement being advantageously affected by heat transferred thereto from said DC to DC converter; and
utilizing said receiving arrangement as a heat sink for accepting heat-energy produced as a by-product from said DC to DC converter during operation, said heat sink advantageously cooling said DC to DC converter during operation.

2. The method as recited in claim 1, further comprising:
operating said DC to DC converter to adjust a power supply voltage at said incorporating arrangement.

3. The method as recited in claim 1, further comprising:
utilizing a component member of said receiving arrangement as said heat sink.

4. The method as recited in claim 1, further comprising:
providing a heat transfer member associated with said DC to DC converter and said receiving arrangement for establishing thermal communication from said DC to DC converter to said receiving arrangement.

5. The method as recited in claim 4, further comprising:
arranging a portion of said heat transfer member into surface-to-surface contact with a portion of said receiving arrangement, said surface-to-surface contact facilitating thermal communication from said DC to DC converter to said receiving arrangement.

6. The method as recited in claim 4, further comprising:
positioning fins on said heat transfer member for dissipating heat out of said transfer member into said receiving arrangement, said dissipation of heat providing a benefit to said receiving arrangement.

7. The method as recited in claim 4, further comprising:
positioning fins on said heat transfer member for dispensing heat out of said transfer member into said receiving arrangement, said dispensation of heat potentiating beneficial effects of said receiving arrangement.

8. The method as recited in claim 1, further comprising:
installing said DC to DC converter into an incorporating arrangement so that heat energy produced by said DC to DC converter is transferred therefrom to said receiving arrangement for a benefit to said incorporating arrangement.

9. The method as recited in claim 8, further comprising:
configuring said DC to DC converter with respect to said receiving arrangement so that heat transferred from said DC to DC converter to said receiving arrangement is applied to a benefited portion of said receiving arrangement that is, at least part time, advantageously affected by heat received from said DC to DC converter.

10. The method as recited in claim 9, further comprising:
selecting said benefited portion of said receiving arrangement that is at least part time advantageously affected by heat received from said DC to DC converter so that sufficient heat is always accepted from said DC to DC converter to provide proper cooling to said DC to DC converter and so that heat transferred from said DC to DC converter to said benefited portion of said receiving arrangement is never disadvantageously affected by the heat received from said DC to DC converter.

11. A method for utilizing heat-energy produced as a by-product from a DC to DC voltage conversion for productive purposes in a carrying vehicle, said method comprising:
providing a DC to DC converter installed in a carrying vehicle, said DC to DC converter producing heat-energy as a by-product of a voltage conversion operation by said DC to DC converter;
arranging said DC to DC converter in thermal communication with a receiving arrangement in said carrying vehicle for transferring heat from said DC to DC converter to said receiving arrangement, said receiving arrangement being advantageously affected by heat transferred thereto from said DC to DC converter; and
utilizing said receiving arrangement as a heat sink for accepting heat-energy produced as a by-product by said DC to DC converter during operation, said heat sink advantageously cooling said DC to DC converter during operation.

12. The method as recited in claim 11, further comprising:
selecting said receiving arrangement to be a windscreen assembly of the carrying vehicle.

13. The method as recited in claim 12, further comprising:
utilizing a windscreen member of said windscreen assembly as a heat-receiving body of said heat sink, said windscreen member having at least partial exterior exposure, outside said carrying vehicle.

14. The method as recited in claim 9, further comprising:
inputting heat from said DC to DC converter into said windscreen at a location opposite a position at which a windshield wiper rests at an exterior surface of said windscreen so that ice formed at said windshield wiper is first melted by input heat, said input heat continuing to be thermally conducted across said windscreen to continue a de-icing effect across said windscreen.

15. The method as recited in claim 11, further comprising:
selecting said receiving arrangement to be an air conducting plenum of an air conditioning system of the carrying vehicle.

16. The method as recited in claim 11, further comprising:
selecting said receiving arrangement to be an air conducting plenum of an air conditioning system of the carrying vehicle, said air conducting plenum directing, at least part time, heated air to be distributed to a passenger compartment of said carrying vehicle.

17. The method as recited in claim 16, further comprising:
providing a heat transfer member associated with said DC to DC converter and said air conducting plenum for establishing thermal communication from said DC to DC converter to an interior passageway of said air conducting plenum.

18. The method as recited in claim 17, further comprising:
exposing at least a portion of said heat transfer member to an air flow conducted through said interior passageway of said air conducting plenum.

19. The method as recited in claim 18, further comprising:
positioning fins on said heat transfer member for potentiating a dissipation of heat out of said transfer member into said air conducting plenum, said dissipation of heat providing a benefit, at least part time, by heating air flowing in said interior passageway of said air conducting plenum prior to said air's distribution to a passenger compartment of the carrying vehicle.

20. An arrangement for utilizing heat-energy produced as a by-product from a DC to DC voltage conversion for productive purposes in a carrying vehicle, said arrangement comprising:
a DC to DC converter installed in a carrying vehicle, said DC to DC converter producing heat-energy as a by-product of a voltage conversion operation by said DC to DC converter;
said DC to DC converter arranged in thermal communication with a receiving arrangement in said carrying vehicle for transferring heat from said DC to DC converter to said receiving arrangement, said receiving arrangement being advantageously affected by heat transferred thereto from said DC to DC converter; and
said receiving arrangement being utilized as a heat sink for accepting heat-energy produced as a by-product by said DC to DC converter during operation, said heat sink advantageously cooling said DC to DC converter during operation.
